(19) United States
(12) Patent Application Publication
(10) Pub. No.: US 2005/0146129 A1
(43) Pub. Date: Jul. 7, 2005

(54) Fringed splash guards and trim

(76) Inventor: William L. Andrews, Rochester, NH (US)

Correspondence Address: William L. Andrews, P.O. Box 1695, Rochester, NH, 03866, US

(21) Appl. No.: 10/752,049

(22) Filed: Jan. 6, 2004

(51) Int. Cl. B62B 9/14

(52) U.S. Cl. 280/851

(57) ABSTRACT

A fringed splash guard used to decoratively protect a vehicle against materials which may be thrown from a vehicles tire. A fringed splash guard can be used on vehicles such as tractor tralers trucks, pick up trucks, vans, cars, and motorcycles. Also provided is a fringed trim and used on a vehicle as a decoration. This fringed trim can also be used as a small splash guard and used to accommodate small vehicles such as motorcycles, a cart, trailers, all terrain, and bicycles.

### FIELD OF THE INVENTION

The invention relates to a rubber splash guard used on a vehicle as protection against materials which may be thrown from a vehicles tire. More particularly, the inventions relates to a decorative splash guard comprising fringe, and used for enhancing the appearance on vehicles such as semi trucks, pickup trucks, vans, cars, and motorcycles.

Also yet, the invention also relates to a decorative trim comprising fringe and used for enhancing the appearance of a vehicle such as semi trucks, pickup trucks, cars, and motorcycles. More particularly, the invention relates to a fringed trim which may be mounted on locations of a vehicle such as along its wheel well, bumpers, bed body, and can also be used as a small splash guard and used on small vehicles.

### BACKGROUND OF THE INVENTION

There are many types of splash guards which are used on vehicles. Two examples are those which are basicly plain and those which are colorful and decorative. The invention relates to splash guards which are colorful and decorative. There are many types of splash guards which are custom molded and conforming to a design. Also there are many splash guards which are colorful and lettered.

What is needed for those who wish to equip their vehicle with a decorative splash guard is a decorative and fringed splash guard. Also what is needed, is a decorative and fringed trim which matches a decorative fringed splash guard.

### DISCRIPTION OF RELATED ART

No related art was found in the field of search in areas 280,851,848,849.

### BRIEF SUMMARY OF THE INVENTION

The present invention features a decorative splash guard comprising fringe. In a preferred embodiment, a splash guard is made of three calendared sheets of rubber which are cut to sized accordingly and place ontop of one another. Each of these sheets can either be all the same color or each can be a different color. One example of a splash guard with different colors is as follows, one sheet of rubber can be red, the second sheet can be white and the third sheet can be blue. Shape's such as stars, letters, logograms, etc. can be cut out of the top sheet. This will allow the color of the middle sheet to show through these shapely cut out areas. Also, shapes and letters can be cut from a separate sheet and placed on top of the top sheet. The bottom sheet can be cut about one inch wider than the middle sheet, the middle sheet can be cut about one inch wider than the top sheet. When these sheets are placed ontop of one another, it's done accordingly so that all three uneven widths are facing toward the same and lower border. A film of a rubber mold release is then placed between each sheet of rubber along the lower and uneven border. The sheets are then vulcanized accordinly so that the sheets cure solidly together. The bordering edge with the film of mold release remains freely separate as three sheets which are cured conformingly into the solidly cured portion of the splash guard. The freely separate edges are then stamped out accordingly so as to form three separate rows of fringe. This preferred embodiment of the invention describes a patriotic red, white, and blue splash guard. The bottom red row of about six inch long fringe will extend about one inch lower than the middle row of about five inch long white fringe. The middle row of white fringe will extend about one inch lower than the top row of about four inch long blue fringe. White star shapes are exposed through and on top of the top blue solid area of the splash guard. This type of splash guard can be made to mount the full width of a vehicle or can be made to mount the width of a vehicles tire.

The present invention also features a fringed trim. The invented fringed trim is made with the same means as a fringed splash guard with the exception of being sized accordingly different. Fringed trim can be mounted on locations of a vehicle such as along and beneath its bed body, wheel wells, bumpers, etc. and also can be used as small splash guards to accomodate small vehicles.

According to the invention this decorative splash guard and trim will enhance the appearance of vehicles such as delivery trucks, tractor trailers, pick ups, vans, cars, and also small vehicles such as motorcycles, all terrain, carts, and bycicles.

### BRIEF DISCRIPTION OF THE DRAWINGS

FIG. 1 shows a view of a patriotic fringed splash guard according to the invention that can mount across the full width of a vehicle.

FIG. 2 shows a view of a pair of patriotic fringed splash guards according to the invention that can mount the width of a vehicles tire.

FIG. 3 shows a view of a patriotic fringed trim that can mount along a vehicle bed body, wheel well, bumper, etc. and can also be used as a small splash guard to accommodate small vehicles.

### DETAILED DISCRIPTION OF THE DRAWINGS

The invention features a decorative fringed splash guard and is used on a vehicle for enhancing the vehicles appearance. The invented fringed splash guard can be made of a solid color or can be made of several colors. Also, the invented fringed splash guard can be made to have incorporable shapes and letters. The invented fringed splash guard can incorporate letters, logograms, business names, telephone numbers, and web sites. The invention can be made patriotically incorporating different colors and shapes.

The invention also features a decorative fringed trim and used on a vehicle for enhancing the vehicles appearance. The invented fringed trim is made with the same means as the invented fringed splash guards. The invented fringed trim and fringed splash guard can be made as matching sets.

A preferred embodiment of the invention features a decorative fringed splash guard patriotically incorporating the colors of red, white, and blue with white star shapes.

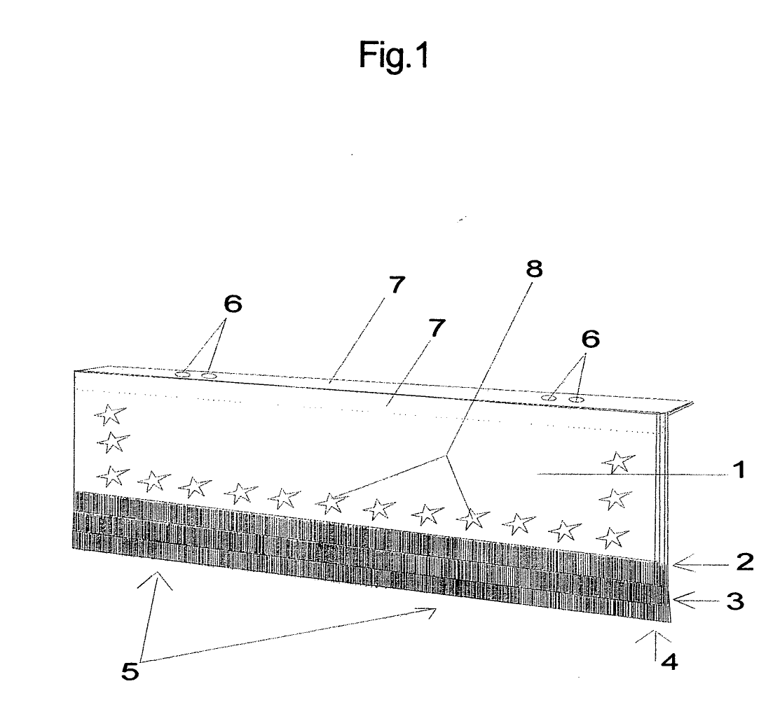

FIG. 1 shows a view of a patriotic fringed splash guard according to the invention that's made to mount across the full width of a vehicle.

FIG. 1 details the following, a fringed splash guard 1, a sheet of blue rubber 2, a sheet of white rubber 3, a sheet of red rubber 4, rows of fringe 5, mounting holes 6, mounting bracket 7, and star shapes 8.

FIG. 1 is described as follows, splash guard 1 is made of rubber. This rubber is preferrably a hypalon so as to withstand deteriorating elements such as ozone. Hypalon also will hold a more brilliant color than other types of rubber. Splash guard 1 can be made of a solid color, such as all black, or even made of the same color of a vehicle its to be mounted onto. Splash guard 1 can also be made of different colors, such as orange and black, or even red, white, and blue, or any variety of colors. Splash guard 1 can be made plain and not incorporate any shapes. Splash guard 1 can also be made incorporating shapes such as a business name, logograms, telephone numbers, and web sites. Splash guard 1 can also incorporate shapes such as stars, musical notes, animals, or any other shapes that someone may desired.

Still referring to a preferred embodiment, also still referring to FIG. 1, splash guard 1 is constructed of a sheet of blue rubber 2, a sheet of white rubber 3, and a sheet of red rubber 4. These sheets of rubber are cut according to a size of vehicle it is to be used on. For example, vehicles such as a large tractor and traitor will require a large size splash guard, a small pick up truck will require a medium size splash guard and a motorcycle will require a small splash guard. However, what ever a size red sheet of rubber 4 is cut, then white sheet of rubber 3 will be cut to a same size except for being cut about one inch narrower. Blue sheet of rubber 2 will be cut the same also, except for being cut one inch narrower than white sheet of rubber 3. Shapes of stars 8 are cut out of blue sheet of rubber 2 at desired locations. Splash guard 1 may be supplied with no mounting bracket and secured onto a vehicle by means of bolting onto a vehicles existing mount. Therefore, the installer will drill holes and bolt through a splash guard 1 accordingly. Splash guard 1 may also be quipped with a mounting bracket. One example of a mounting bracket, but not limited to, is described as follows. Mounting bracket 7 is preferably a aluminum angle. Bracket 7 is cut the length of splash guard 1. One angle side of mounting bracket 7 can accommodate holes 6. Holes 6 are used to accommodate bolts through, when splash guard 1 is to be secured onto a vehicle by means of bolts. Holes 6 are located according to a vehicles design. Opposite angle side of bracket 7 is bonded directly onto splash guard 1. Bonding of bracket 7 is described in this paragraph to follow. Sheet of white rubber 3 is evenly placed onto sheet of red rubber 4 accordingly so that red sheet 4 extends beyond lower portion of white sheet 3. Sheet of blue rubber 2 is evenly placed onto white sheet 3 accordingly so that white sheet 3 extend beyond lower portion of blue sheet 2. Red sheet 4 and white sheet 3 both extends beyond blue sheet 2 at the same lower portion. This will expose all three colors bordering along a lower portion of splash guard 1. A suitable rubber to metal bonding adheasive, such as CHEMLOC 250, is applied to bracket 7 over the angle side in which to bond onto splash guard 1. Prepared bonding side of bracket 7 is place in between blue sheet 2 and white sheet 3. Splash guard 1 is then place into a suitable oven or mold for vulcanizing and curing.

A preferred oven is an open pressure autoclave that is equipped with means of providing a dry heat of 300 degrees in Fahrenheit and about 60 pounds of air pressure. Also, a rubber mold used in a hydraulic press is a suitable oven as well. Splash guard 1 is placed into an open pressure autoclave accordingly so that red sheet 4 is on bottom. A film of a rubber mold release is then placed between each sheet of rubber along the lower border of splash guard 1. Splash guard 1 is then vulcanized for about one hour at about 300 degrees in Fahrenheit and under about 60 pounds of air pressure. Splash guard 1 is then removed from the autoclave and cooled. The three sheets of rubber of splash guard 1 cured solidly together. The lower border of splash guard 1, where a rubber mold release was applied, remains freely separate as three bordering edges that cured conformingly into the solidly cured area. These three bordering edges are then stamped out accordingly so as to make three separate rows of fringe 5. Each row of fringe 5 is of a red, white, or blue color. The red bottom and lowest row of about six inch long fringe will extend about one inch lower than the middle row of about five inch long white fringe. The middle row of white fringe will extend about one inch lower than the top row of about four inch long blue fringe. Fringe 5 will have a fluttery motion when the winds passes through. This fluttery affect also enhances a vehicle appearance.

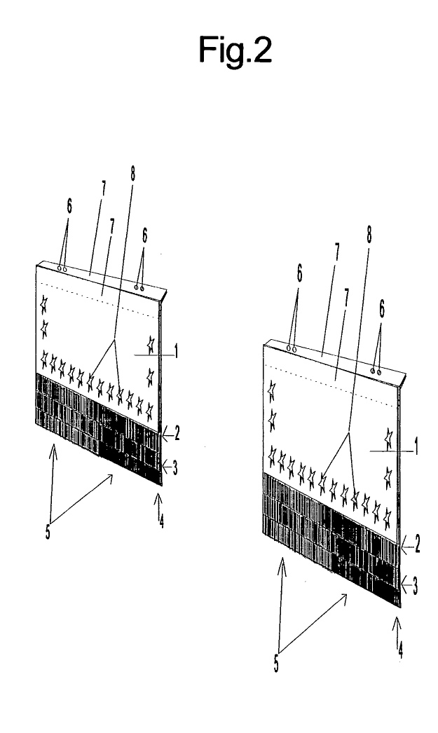

FIG. 2 shows a view of a pair of patriotic splash guards according to the invention that can mount the width of a vehicles tire. FIG. 2 details the same details as FIG. 1.

FIG. 2 details the following, a fringed splash guard 1, a sheet of blue rubber 2, a sheet of white rubber 3, a sheet of red rubber 4, rows of fringe 5, mounting holes 6, mounting bracket 7, and star shapes 8.

FIG. 2 is described same as description in FIG. 1 with the exception of size. FIG. 2 is described as follows, splash guard 1 is constructed of a sheet of blue rubber 2, a sheet of white rubber 3, and a sheet of red rubber 4. These sheets of rubber are cut to a size according to a vehicles tire. These sheets are placed on top of each other as described in FIG. 1. Also, star shapes 8 can be cut out of blue sheet 2 and star shapes can be cut from a separate sheet of rubber, (not detailed), and placed onto blue sheet 2.

Mounting bracket 7 is preferably an aluminum angle. One angle side of bracket 7 can accommodate holes 6. These holes can be used to place bolts through when splash guard 1 is to be secured to a vehicle by means of bolting. Opposite angle side of bracket 7 is bonded onto splash guard 1 accordingly as described in FIG. 1. Splash guard 1 is then prepared with a mold release and vulcanized accordingly as described in FIG. 1. Lower border of splash guard 1 is then stamped out accordingly so as to make rows of fringe 5. Star shapes 8 cured conformingly onto blue area of splash guard 1.

Still referring to FIG. 2, Splash guard 1 can be secured onto a vehicle by a variety of means. One example is by securing a splash guard 1 by chain like sometimes found on a construction vehicle. Another example of means to secure a splash guard 1 to a vehicle is by clamping. Splash guard 1 can be made either with or without a mounting bracket 7. Splash guard 1 can be cut to fit a design of a vehicle such as a car or a van and secured by means of screwing to the vehicles wheel well and inner fender.

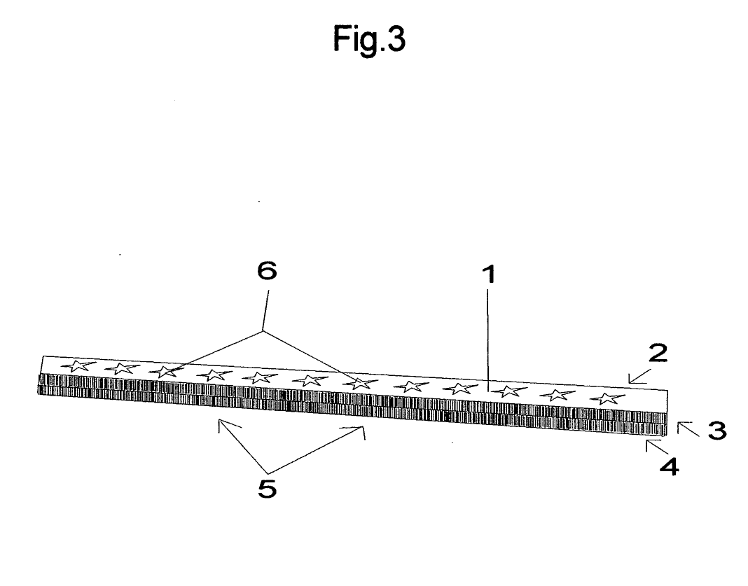

The invention also features a decorative fringed trim and is used on a vehicle for enhancing a vehicles appearance. The invented fringed trim is made with the same means as the invented fringed splash guard. FIG. 3 shows a view of a patriotic fringed trim and can be secured along places such as a vehicles body, wheel well, bumper, etc.

FIG. 3 details the following, a fringed splash guard 1, a sheet of blue rubber 2, a sheet of white rubber, a sheet of red rubber, rows of fringe 5, and star shapes 6.

FIG. 3 is described as follows, splash guard 1 is constructed of three sheets of calendared rubber. Rubber used is preferably hypalon due to its resistance to ozone and capabilitys of holding long lasting brilliant colors. One sheet of rubber is a color blue 2, one sheet of rubber is a color white 3, and one sheet of rubber is red 4. Blue sheet 2 is cut to a size of about eight feet long and two inches wide. Star shapes 6 are cut out of blue sheet 2 to desired size and at desired locations. As an option, star shapes can be cut from a separate sheet of rubber and placed onto blue sheet 2. White sheet 3 is cut to a size of about eight feet long and four inches wide. Red sheet 4 is cut to a size of about eight feet long and six inches wide. The three sheets are then place evenly on top of each other and all aligned on a same top edge. Six inch wide red sheet 4 will be on bottom and two inch wide blue sheet 2 will be on top. Remaining four inch wide white sheet 3 will be in the middle. A film of suitable rubber mold release is then applied along and in between the lower portion of white sheet 4 and red sheet 3. The prepared sheets are then placed in a suitable oven or mold and cured. (A mold used with a press will be a more productive means for curing as apposed to an open dry heat autoclave. If a mold method is used, then a mold will be machined to specific shapes and sizes. An open dry heat autoclave that can hold about sixty to eighty pounds per sqare inch of air pressure will be a more versatile means of curing as apposed to a mold.) Sheets of rubber is then removed from the oven and cooled. The three sheets of rubber cured solidly together except across the lower portion and in between sheet 3 and sheet 4 where mold release was applied. This area remains freely separate and cured conformingly into the solidly cured area. When star shapes 6 are cut into blue sheet 2, then white sheet 3 will uniformingly show through these star shapes 6 of blue sheet 2. When star shapes 6 are cut from a separate sheet of rubber and placed onto blue sheet 2, Then these star shapes 6 will cure conformingly onto blue sheet 2. By means of stamping and cutting, the lower portion of white sheet 3 and red sheet 4 is cut into two rows of fringe 5.

The invented fringed trim can be made a variety of colors and can also be made incorporating a variety of different shapes and figures. The invented fringed trim can be secured along a vehicles bed body, bumper or where ever one may desire. The invented fringed trim can be made in long lengths and cut to shorter desired lengths. The invented fringed trim can also be used as a small splash guard to accommodate small vehicles such as motorcycles, bicycles, trailer, carts, all terrain, and snowmobiles. The invented fringed trim can incorporate patriotic colors and shapes.

The invention features a decorative fringed splash guard and trim. The invented fringed splash guard and trim is used on a vehicle as a protection against materials which may be thrown from a vehicles tire. The invented fringed splash guard and trim is also used to decorate a vehicle and for enhancing the appearance of a vehicle.

It is recognized that various alterations are possible by one of ordinary skill in the art and within the scope of the claims to follow.

1. A fringed splash guard, comprising:
a decorative rubber splash guard incorporating a rubber fringe across its lower border and used to decoratively protect a vehicle against materials which may be thrown from its tire; and
A fringed splash guard incorporating rubber shapes which are cured conformingly in its solid area; and
A fringed trim, comprising:
a rubber trim incorporating a rubber fringe across its lower border; and
A fringed trim incorporating rubber shapes which are cured conformingly in its solid area.

2. The fringed splash guard of claim 1, wherein said guard can be made of one color or it can be made of a variety colors.

3. The rubber shapes of claim 1, wherein said shapes can be such as that of logograms, letters, and symbols.

4. The fringed splash guard of claim 1, wherein said guard is made of rubber incorporating a rubber fringe across its lower border.

5. The fringed splash guard of claim 1, wherein said guard can be made incorporating patriotic colors and shapes.

6. The fringed splash guard of claim 1, wherein said guard can be made to a size according to a size of a vehicle it's to be used with.

7. The fringed splash guard of claim 1, wherein said guard can be equipped either with or without a mounting bracket.

8. The fringed splash guard of claim 1, wherein said guard can be made to mount across the full width of a vehicle.

9. The fringed splash guard of claim 1, wherein said guard can be made to mount across the width of a vehicles tire.

10. The fringed splash guard of claim 1, wherein said guard can be cut to fit a profile of a vehicle and screwed to the vehicles wheel well and inner fender.

11. A fringed trim, comprising:
a rubber trim incorporating rubber fringe across its lower border; and
A fringed trim incorporating rubber shapes which are cured conformingly into its solid area.

12. The fringed trim of claim 11, wherein said trim can be made of one color or it can be made of several colors.

13. The fringed trim of claim 11, wherein said trim is made of rubber incorporating a rubber fringe across its lower border.

14. The rubber shapes of claim 11, wherein said shapes can be such as that of logograms, letters, and symbols.

15. The fringed trim of claim 11, wherein said trim can be made incorporating patriotic colors and shapes.

16. The fringed trim of claim 11, wherein said trim can be made in lengths of eight feet and cut to shorter lengths.

17. The fringed trim of claim 11, wherein said trim can also be used as small splash guards to accommodate small vehicles.

18. The fringed splash guard and trim of claim 1, wherein said guard and trim can be made as matching sets.
